(19) United States
(12) Patent Application Publication
(10) Pub. No.: US 2015/0139483 A1
(43) Pub. Date: May 21, 2015

(54) Interactive Controls For Operating Devices and Systems

(71) Applicant: David Shen, San Jose, CA (US)

(72) Inventor: David Shen, San Jose, CA (US)

(21) Appl. No.: 14/081,953

(22) Filed: Nov. 15, 2013

(51) Int. Cl. H05B 37/02; G10L 15/22; G06K 9/00

(52) U.S. Cl. CPC H05B 37/0272; G06K 9/00355; G10L 15/22; G10L 2015/223
USPC 382/103

(57) ABSTRACT

An electric device (e.g., module, interactive controller/switch) comprising a gesture sensor can use the gesture sensor to determine (e.g., detect, recognize, identify, etc.) a gesture performed by a user. If the electric device recognizes the gesture as corresponding to a gestural command to control or operate another device and/or system (e.g., such as a light), then the electric device can instruct the other device/system to function or operate in accordance with the gestural command (e.g., turn on or off). In some embodiments, the electric device can also comprise an audio sensor configured to capture audio data. The captured audio data can include a vocal command given by the user. The electric device can analyze the captured audio data. Based on the analysis, if the electric device recognizes the vocal command, then the electric device can cause the other device/system to function or operate in accordance with the vocal command

### BACKGROUND

Various devices and systems, such as electric devices and systems, play significant roles in people's everyday lives. Often times these devices and systems can be used, operated, or interacted with through the use of controls, switches, buttons, or other user interfaces. For example, people can flip a conventional light switch to turn on and turn off lights in a room. In another example, a user of a garbage disposal device/system can flip a conventional switch to operate the garbage disposal device/system. In a further example, a person can press a conventional button to open or close a garage door. People also use conventional switches, buttons, and other interfaces for many other purposes as well. However, in at least some cases, conventional switches, buttons, dials, controls, and other similar interfaces can be boring to use and/or can lack interactivity with respect to users. Further, in an example scenario involving a conventional light switch, a user of the conventional light switch may find it difficult or inconvenient to locate the conventional light switch, especially in a dark room or environment. Moreover, in other example scenarios, users may worry about whether or not they unintentionally left on the lights in their houses and/or left open the garage door. These and other concerns can take away from the overall user experience associated with using various devices and/or systems.

### BRIEF DESCRIPTION OF THE DRAWINGS

Various embodiments in accordance with the present disclosure will be described with reference to the drawings, in which:

FIG. 1 illustrates an example scenario for utilizing an interactive controller to operate one or more devices and/or systems;

FIG. 2 illustrates an example scenario for utilizing an interactive controller to operate one or more devices and/or systems;

FIG. 3A illustrates an example device embodiment for interactively controlling one or more devices and/or systems;

FIG. 3B illustrates an example device embodiment for interactively controlling one or more devices and/or systems;

FIG. 3C illustrates an example device embodiment for interactively controlling one or more devices and/or systems;

FIG. 3D illustrates an example device embodiment for interactively controlling one or more devices and/or systems;

FIG. 4A illustrates an example scenario for utilizing an interactive controller to operate one or more devices and/or systems;

FIG. 4B illustrates an example scenario for utilizing an interactive controller to operate one or more devices and/or systems;

FIG. 4C illustrates an example scenario for utilizing an interactive controller to operate one or more devices and/or systems;

FIG. 5 illustrates an example device embodiment for interactively controlling one or more devices and/or systems;

FIG. 6A illustrates an example method embodiment for interactively controlling one or more devices and/or systems;

FIG. 6B illustrates an example method embodiment for interactively controlling one or more devices and/or systems;

FIG. 7 illustrates an example device that can be used to implement aspects of the various embodiments;

FIG. 8 illustrates example components of a client device such as that illustrated in FIG. 7; and

FIG. 9 illustrates an environment in which various embodiments can be implemented.

### DETAILED DESCRIPTION

Systems and methods in accordance with various embodiments of the present disclosure overcome one or more of the above-referenced and other deficiencies in conventional approaches to interacting with computing devices. In particular, various embodiments of the present disclosure can provide an interactive control or switch for controlling or operating one or more devices and/or systems.

In at least some embodiments, an electric device (e.g., module, interactive controller/switch) can comprise at least one gesture sensor. The electric device can use the at least one gesture sensor to determine (e.g., detect, recognize) a gesture performed by a user. If the electric device recognizes the gesture as corresponding to a gestural command to control or operate another device and/or system, then the electric device can instruct the other device/system to function or operate in accordance with the gestural command.

Furthermore, in some embodiments, the electric device can comprise at least one audio sensor. The electric device can use the at least one audio sensor to capture audio data. The captured audio data can include a vocal command given by the user. The electric device can analyze the captured audio data. Based on the analysis, if the electric device recognizes the vocal command, then the electric device can cause the other device/system to function or operate in accordance with the vocal command.

In some instances, the electric device can control or operate the other device/system by causing power to be provided to the other device/system or by causing power provided to the other device/system to be limited (including ceasing from being provided). In other words, in some instances, the electric device can cause the other device/system to function or operate in accordance with a user command by controlling whether or not (or how much) power is provided to the other device/system.

In some cases, power can be provided to the other device/system via a physical controller (e.g., relay, switch, variable resistor, etc.) that is electrically connected to the other device/system. In some embodiments, the physical controller can be electrically connected to the electric device as well. The electric device can cause the physical controller (e.g., relay, switch, variable resistor, etc.) to enter a first state (e.g., a relay/switch entering a closed circuit state), which results in power being provided to the other device/system. The electric device can also cause the physical controller to enter a second state (e.g., a relay/switch entering an open circuit state), which results in provided power to cease from being provided to the other device/system.

In one example, the electric device or module can correspond to an interactive control or switch for controlling a light. The interactive control/switch can be wall-mounted, similar to a conventional wall-mounted light switch. In this example, the interaction control/switch can comprise a gesture sensor and a microphone. When a user moves his/her hand upward in front of the interactive control/switch, the interactive control/switch can cause the light to turn on, such as by causing a physical controller (e.g., relay) to enter a closed circuit state which results in power being provided to the light. When the user moves his/her hand downward in front of the interactive control/switch, the interactive control/switch can cause the light to turn off, such as by causing the physical controller (e.g., relay) to enter an open circuit state which results in ceasing to provide power to the light. Similarly, when the user issues a vocal command (e.g., “Lights On”), then the interactive control/switch can cause the light to turn on (e.g., by providing power to the light via the physical controller). When the user issues another vocal command (e.g., “Lights Off”), then the interactive control/switch can cause the light to turn off (e.g., by ceasing to provide power to the light via the physical controller).

Other variations, functions, and advantages are described and suggested below as may be provided in accordance with the various embodiments.

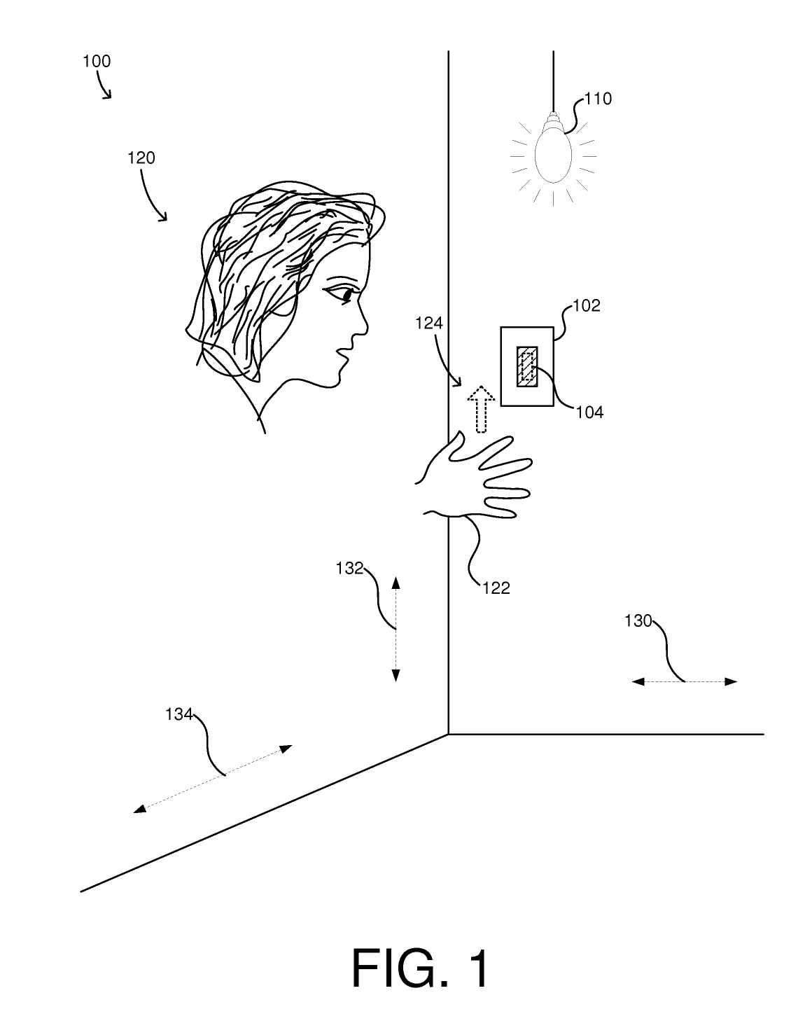

FIG. 1 illustrates an example scenario 100 for utilizing an interactive controller to operate one or more devices and/or systems. The example scenario 100 can comprise a module configured to control or operate a device and/or system. In some embodiments, the module can comprise one or more switches, buttons, levers, controls, and/or other interfaces, etc., which can be used by a user 120 to control or operate the device and/or system. In the example of FIG. 1, the device and/or system can correspond to a light source 110 and the module can correspond to a light switch/controller 102 for turning on, off, dimming, and/or otherwise controlling the light source 110.

In some embodiments, the module (e.g., light switch 102) can comprise a gesture sensor 104. The gesture sensor 104 can be configured to determine (e.g., detect, recognize, identify, etc.) one or more gestures initiated or performed by the user 120. As shown in the example of FIG. 1, the user 120 can move his/her hand 122 in a substantially upward direction 124 within an allowable distance from (the gesture sensor 104 of) the light controller module 102 (e.g., approximately 0 to 20 centimeters or more). In particular, the user 120 can, for example, place his/her hand 122 a short distance away from (the gesture sensor 104 of) the light controller module 102 in the Z-axis 134, and then the user 120 can move his/her hand 122 upward 124 in the Y-axis 132, while being in substantially the same the X-axis 130 position as the light controller module 102. The gesture sensor 104 of the light controller module 102 can determine that an object (e.g., the hand 122 of the user 120) has moved in a substantially upward direction 124. The gesture sensor 104 can associate the determined upward movement 124 of the object 122 with a first gesture. The first gesture can cause the light source 110 to turn on. Accordingly, in the example of FIG. 1, in response to the gesture sensor 104 determining (e.g., detecting, recognizing) the upward movement 124 of the user's hand 122 (e.g., first gesture), the light controller module 102 can cause the light source 110 to emit light (e.g., turn on). Although not explicitly shown in FIG. 1, the user 120 can move his/her hand 122 in a substantially downward movement (e.g., a second gesture) to cause the light source 110 to cease light emission (e.g., turn off).

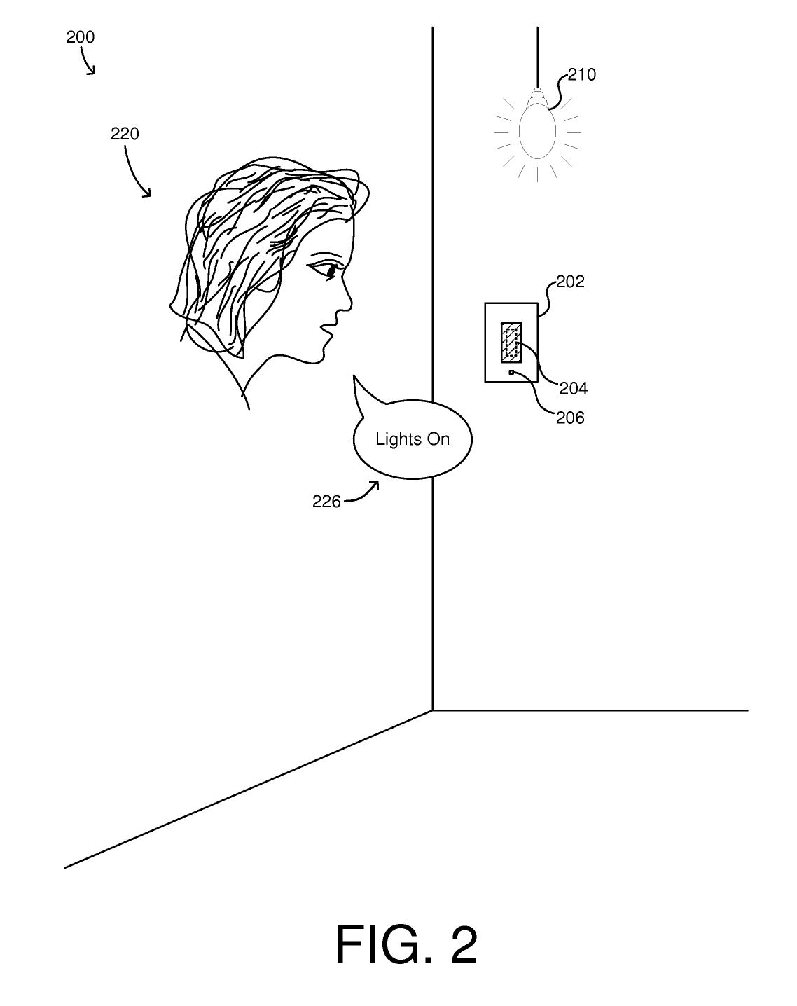

Turning now to FIG. 2, an example scenario 200 for utilizing an interactive control to operate one or more devices and/or systems is illustrated. In FIG. 2, module 202 can correspond to an interactive control configured to control or otherwise operate a device or system, such as a visible light emitter 210 (e.g., a light source that emits visible light). The module or interactive control 202 can comprise at least one gesture sensor 204 and at least one audio sensor (e.g., microphone, audio capture component) 206. As discussed above, the gesture sensor 204 can detect and/or recognize one or more gestures performed by a user 220 of the module (e.g., control, switch, etc.) 202. In one example, the user 220 can move his or her hand upward in front of the module 202 to cause the device or system (e.g., the visible light emitter 210) to turn on. In another example, the user 220 can move his or her hand downward in front of the module 202 to cause the device/system to turn off.

The at least one audio sensor (e.g., microphone) 206 included in the module 202 can be configured to facilitate in determining (e.g., detect, identify, recognize, etc.) one or more commands spoken, vocalized, uttered, or otherwise initiated by the user 220. In the example of FIG. 2, the user 220 can say the words “Lights On” 226. The module 202 can use the at least one audio sensor 206 to capture audio data over time. The captured audio data can be analyzed using one or more audio data processing techniques, such as one or more speech/keyword/key-phrase recognition algorithms. The audio sensor 206 (or the interaction control/module 202) can thus determine that the key phrase “Lights On” 226 corresponds to a vocal command instructing the visible light emitter 210 to turn on. Accordingly, the module 202 can transmit a signal to cause the visible light emitter 210 to turn on.

In some embodiments, the at least one gesture sensor 204 of the module 202 and the at least one audio sensor 206 of the module 202 can work in conjunction. In one example, the user 220 can move or wave his or her hand in an upward direction in front of the module 202. As a result, the gesture sensor 204 of the module 202 can recognize the user-initiated gesture and the module 202 can cause the lights 210 to turn on. Subsequently, the user 220 can turn off the lights 210 by giving a vocal command, such as “Lights Off”. In another example, the user 220 can turn on the lights 210 by saying “Lights On”, and then turn off the lights 210 by performing a downward hand gesture (e.g., wave, motion, movement, etc.). As such, the user 220 can have multiple ways of interacting with the module 202 to control or operate the light 210.

In some embodiments, noise suppression, noise filtering, and/or noise reduction can be applied to the captured audio data. A noise suppression, filtering, and/or reduction process (e.g., technique, algorithm, etc.) can be applied to the captured audio data to suppress, filter out, and/or reduce noise or other undesired qualities that may be present in the captured audio data. For example, the noise suppression, noise filtering, and/or noise reduction, etc., can enable the module to more accurately recognize the captured audio data when there is background or ambient noise.

Moreover, in some embodiments, a user authentication and/or authorization process can be implemented. In one example, the user authentication/authorization process can be performed when the captured audio data is being analyzed (e.g., performed during the speech recognition algorithm). The user authentication and/or authorization process can enable the module to differentiate between different users (i.e., between different users' voices). In some cases, only an authorized/authenticated user(s) can effectively give a vocal command(s).

In addition, in some embodiments, the module can be configured to recognize various languages. As such, a first user can issue vocal commands in one language while a second user can issue vocal commands in another language. Recognizing different languages also enables the module to be utilized in various places in the world.

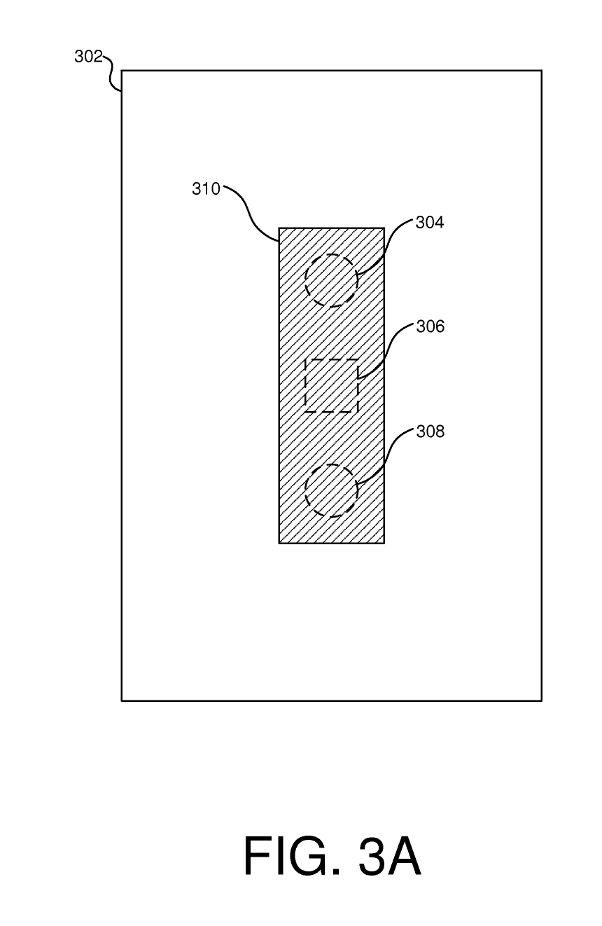

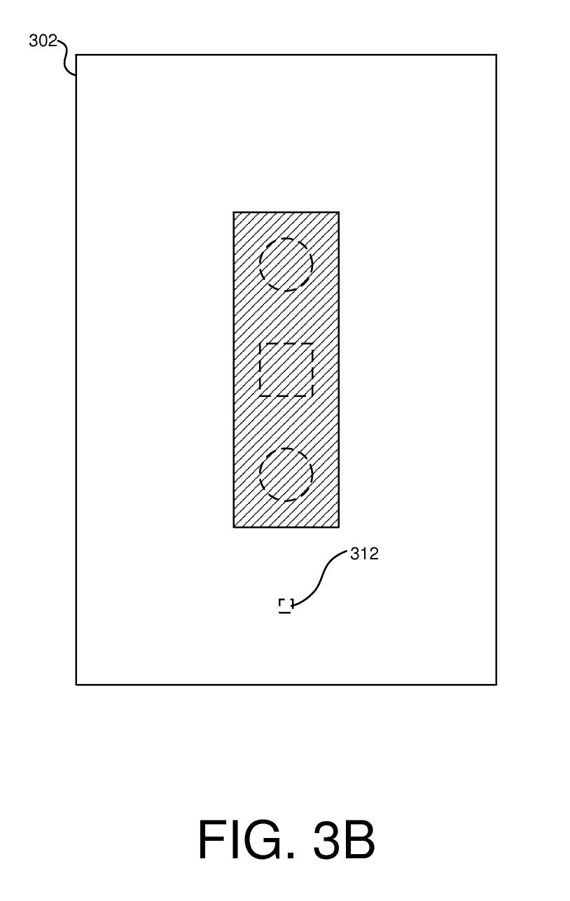

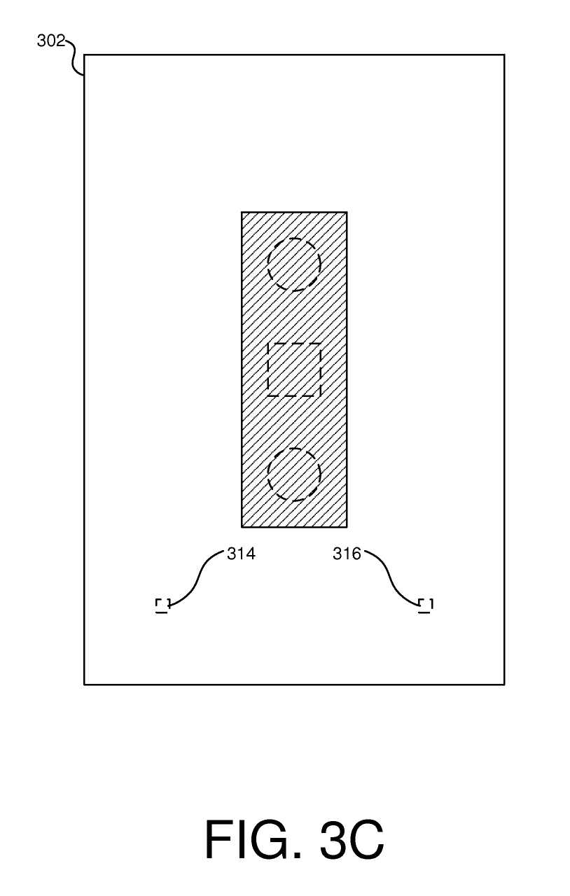

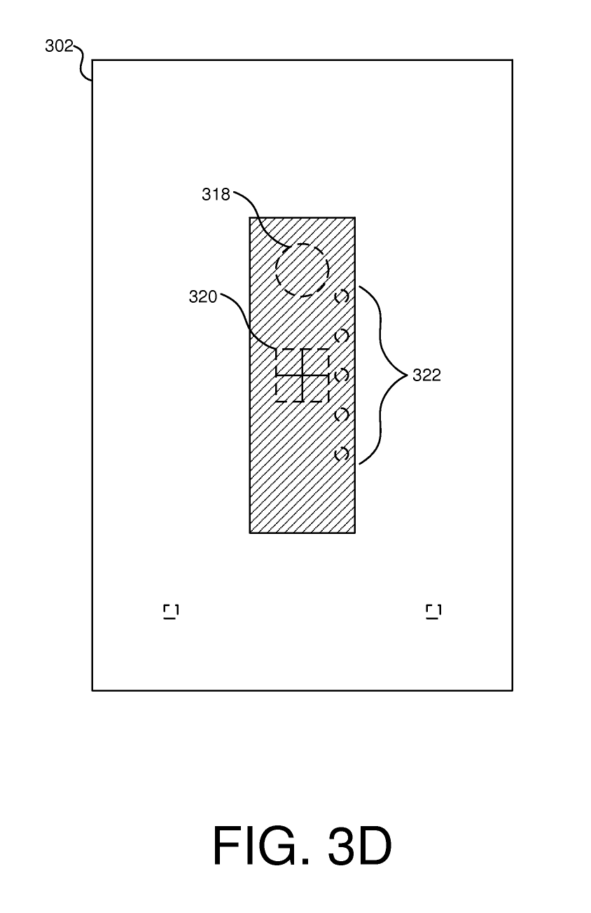

With reference now to FIG. 3A, an example device embodiment 302 for interactively controlling one or more devices and/or systems is illustrated. The example device 302 can correspond to the module or interactive control/switch discussed previously (e.g., 102 in FIG. 1, 202 in FIG. 2). The example device 302 can comprise a gesture sensor. As shown in FIG. 3A, the gesture sensor can include, at least in part, one or more invisible light emitters (e.g., 304, 308) and at least one invisible light sensor (e.g., 306). In general, the gesture sensor can determine (e.g., detect, recognize, identify, etc.) a gesture by emitting invisible light (e.g., infrared (IR) light) and sensing at least a portion of the invisible light reflected back when an object is within an allowable distance from the invisible light emitter. By analyzing whether and how the at least the portion of the invisible light is reflected back, the gesture sensor (or the device 302) can attempt to determine what, if any, gesture(s) has been performed. Further, in some embodiments, there can be a tinted/darkened window or cover 310 over the emitter(s) and sensor(s), such as for aesthetic purposes.

In the example of FIG. 3A, the upper invisible light emitter (e.g., IR light emitting diode (LED)) 304 is physically located above (e.g., Y-axis) the lower invisible light emitter (e.g., IR LED) 308. As such, assuming that invisible light is being emitted by both emitters (304 and 308), then if the invisible light sensor 306 detects invisible light (e.g., IR light) emitted from the upper emitter 304 (and reflected back by an object, such as a user's hand) before detecting invisible light (e.g., IR light) emitted from the lower emitter 308 (and reflected back by the object, such as the user's hand), then the device 302 can recognize that the object reflecting back invisible light was first at an upper position and then at a lower position. Accordingly, the device 302 can determine that there was a downward movement/gesture. In other words, the device 302 can determine that the object (e.g., user's hand) has moved from a relatively upper position to a relatively lower position.

In some embodiments, the device 302 (or the gesture sensor, or the invisible light sensor 306 of the gesture sensor) may need to distinguish between the invisible light emitted from the upper emitter 304 and the invisible light emitted from the lower emitter 308. One example approach to accomplish this involves the upper emitter 304 and the lower emitter 308 emitting invisible light at differing time intervals, such as at differing pulses. The upper emitter 304 can, for example, emit invisible light at time periods 1, 3, 5, and so forth, while ceasing to emit at time periods 2, 4, 6, and so on. In contrast, the lower emitter 308 can, for example, emit invisible light at time periods 2, 4, 6, and so forth, but cease to emit at time periods 1, 3, 5, etc. In some embodiments, each time period can be short relative to the duration of a gesture. In some cases, each time period can be a fraction of a second (e.g., microseconds, millisecond, etc.).

The gesture sensor can have access to information about when each emitter is emitting light and when each emitter is not emitting light. As such, the gesture sensor can determine whether the invisible light detected by the invisible light sensor 306 originated from the upper emitter 304 or from the lower emitter 308. For example, if the invisible light sensor 306 senses or detects invisible light at, within, or substantially near (i.e., within an allowable deviation from) time periods 1, 3, and/or 5, etc., then the gesture sensor can recognize that the detected invisible light originates from the upper emitter 304. If the invisible light sensor 306 senses light at, within, or substantially near time periods 2, 4, and/or 6, etc., then the gesture sensor can recognize that the detected invisible light originates from the lower emitter 308. Then, as discussed above, if invisible light originating from the upper emitter 304 is detected before invisible light originating from the lower emitter 308 is detected, then the gesture sensor can determine that there has been a downward gesture. Similarly, if invisible light originating from the lower emitter 308 is detected before invisible light originating from the upper emitter 304 is detected, then the gesture sensor can recognize that there has been an upward gesture. Based on the gesture, the device 302 can cause another device (or system) to function or operate as instructed.

It is further contemplated that a person having ordinary skill in the art would recognize various other approaches, systems, processes, and/or techniques, etc. that can be used with the various embodiments of the present disclosure to determine (e.g., detect, recognize, identify) gestures. In one example, the device 302 can comprise at least two invisible light emitters and at least two invisible light sensors. The device 302 can have an upper invisible light emitter and an upper invisible light sensor, and also a lower invisible light emitter and a lower invisible light sensor. As such, the device 302 can use the upper sensor to detect invisible light emitted from the upper emitter, and can use the lower sensor to detect invisible light emitted from the lower emitter. In this example, the emitters need not emit light at differing time intervals. In another example, the invisible light emitter(s) and/or invisible light sensor(s) can be positioned differently, such as the emitters being positioned along a substantially horizontal axis (e.g., X-axis) resulting in a left emitter and a right emitter. In this example, the device 302 can be capable of determining leftward gestures/movements and rightward gestures/movements. In a further example, the gesture sensor can correspond to an image capture component (e.g., a camera), and gestures can be determined using, at least in part, one or more image processing techniques/algorithms. A person of ordinary skill in the art would recognize that many other variations consistent with the present disclosure can be implemented as well.

Turning now to FIG. 3B, FIG. 3B illustrates the example device embodiment 302 of FIG. 3A for interactively controlling one or more devices and/or systems. As shown in the example of FIG. 3B, the example device 302 can comprise at least one audio sensor (e.g., audio capture component, microphone, etc.) 312. As previously discussed, the device 302 can, for example, use the audio sensor 312 to detect, capture, and/or recognize one or more vocal commands for controlling one or more devices and/or systems.

Moreover, in some embodiments, the example device 302 can comprise multiple audio sensors (e.g., 314, 316), such as an array of audio sensors. Each of the multiple audio sensors can be placed a minimum allowable distance away from the other(s). For example, as shown in FIG. 3C, there can be two audio sensors (e.g., 314, 316) that are separated by an allowable/threshold distance (e.g., a few centimeters). In some embodiments, the audio sensors can be used to determine or calculate a location from which audio data originates. For example, if a user utters a vocal command, the multiple audio sensors can attempt to approximate a location, distance, direction, and/or other locational information associated with the utterance made by the user. In some cases, the locational information (e.g. relative location, distance, direction, geographical information, etc.) associated with an utterance or sound from an audio source (e.g., a user) can be used to determine which device, out of a plurality of devices, the audio source had intended to direct the sound or utterance. For example, in some embodiments, if there are two devices (e.g., interactive controls/switches/modules), each having multiple audio sensors, then when a user gives a vocal command, the devices can determine to which device the user had likely intended for the vocal command to be directed.

In some embodiments, beaming forming can be implemented using the multiple audio sensors. In some cases, beam forming can enable audio to be captured when the source of the audio is positioned in a particular area and/or direction, while audio outside the area would not be captured (or would be ignored). In one example, beam forming using the multiple audio sensors can create a (virtual) cone or zone of audio detection or audio detectability, such that when the user gives a vocal command within the cone or zone, then the module can receive the vocal command; whereas if the vocal command was given at an area/direction outside the cone/zone, then the vocal command would be ignored. Accordingly, in some embodiments, if there are multiple modules in an environment, each module can establish its own respective cone or zone of audio detection/detectability.

As discussed above, a person of ordinary skill in the art would recognize that many other variations consistent with the present disclosure can be implemented as well. FIG. 3D illustrates an example device embodiment 302 for interactively controlling one or more devices and/or systems. The example device 302 can comprise one invisible light emitter 318 and one invisible light sensor 320. In the case where only one invisible light sensor (e.g., 320) is used, the invisible light sensor 320 can include multiple (two or more) channels (e.g., portions, parts, sections, lens, etc.). In the example of FIG. 3D, the invisible light sensor 320 can include four channels (e.g., portions, parts, sections, quadrants, lens, etc.).

In some instances, each of the multiple channels can be directed in a particular direction or positioned in a particular way. For example, each channel can be angled to detect invisible light coming from a certain direction, location, or area. In another example, one or more blocking elements can be placed between channels, such that one channel can only detect invisible light from one direction/location/area while another channel can only detect invisible light from another direction/location/area. In the example case of detecting only upward and downward gestures, the invisible light sensor can comprise two channels, one channel positioned/directed to detect invisible light from a top direction/location/area and one channel positioned/directed to detect invisible light from a bottom direction/location/area. In this example case, the invisible light emitter 318 can emit invisible light. When a user's hand moves from top to bottom, the top channel will detect invisible light (reflected back from the user's hand at the top) before the lower channel detects invisible light (reflected back from the user's hand at the bottom). Accordingly, the device 302 can determine that a downward swiping/moving/waving gesture has been performed. Similarly, if the lower channel detects invisible light before the upper channel does, then the device 302 can determine that an upward gesture has been performed. Moreover, in some embodiments, if the two channels are positioned left and right (relative to each other), then left and right gestures can be detected/determined.

In another example, the device 302 can comprise four channels (as shown in FIG. 3D). The four channels can facilitate in determining upward, downward, left, right, diagonal, and/or rotational, etc., gestures. For example, if the two upper channels detect invisible light before the two lower channels do, then the device 302 can determine that a downward gesture has been performed (and vice versa for an upward gesture). In another example, if the two right channels detect invisible light before the two left channels do, then the device 302 can determine that a left gesture has been performed (and vice versa for a right gesture). In a further example, if the upper left channel detects invisible light before the lower right channel does, then the device 302 can determine that a diagonal (upper left to lower right) gesture has been performed. (Other diagonal gestures, such as lower right to upper left, upper right to lower left, and lower left to upper right, can similarly be determined using the multiple channels.) In another example, a clockwise gesture can be determined when each of the multiple channels detects invisible light in a clockwise sequence (e.g., upper right channel, then lower right channel, then lower left channel, then upper left channel, etc.), and vice versa for a counterclockwise gesture.

Additionally or alternatively, in some embodiments, instead of using multiple channels in an invisible light sensor, multiple invisible light sensors can be utilized as well. Again, a person of ordinary skill in the art would recognize that many other variations consistent with the present disclosure can be implemented as well.

Moreover, in some embodiments, the device 302 can include one or more indicators 322. For example, if the device (or system) 302 controls or operates (e.g., provides/limits power to) another device/system, then there can be one or more lights (e.g., LED indicator lights) that indicate whether or not (or how much) power is being provided to the other device/system. For example, if only one indicator is used for the other device/system, then the indicator can be on when the other device/system is on, and off when the other device/system is off. In another example, if two indicators are used for the other device/system, then one of the indicators can be on by default, while the other indicator turns on or off when the other device/system turns on or off. In a further example, if the other device/system is a light or a set of lights that can dim or brighten, then there can be multiple indicators to indicate how dim or bright the light is. (It is further contemplated that the device 302 can similarly control the volume for audio playback as well as other incremental/decremental features of other devices/systems.) Moreover, in some embodiments, if the device (or system) 302 controls or operates multiple other devices/systems, then each of the multiple other devices/systems can be associated with at least one indicator.

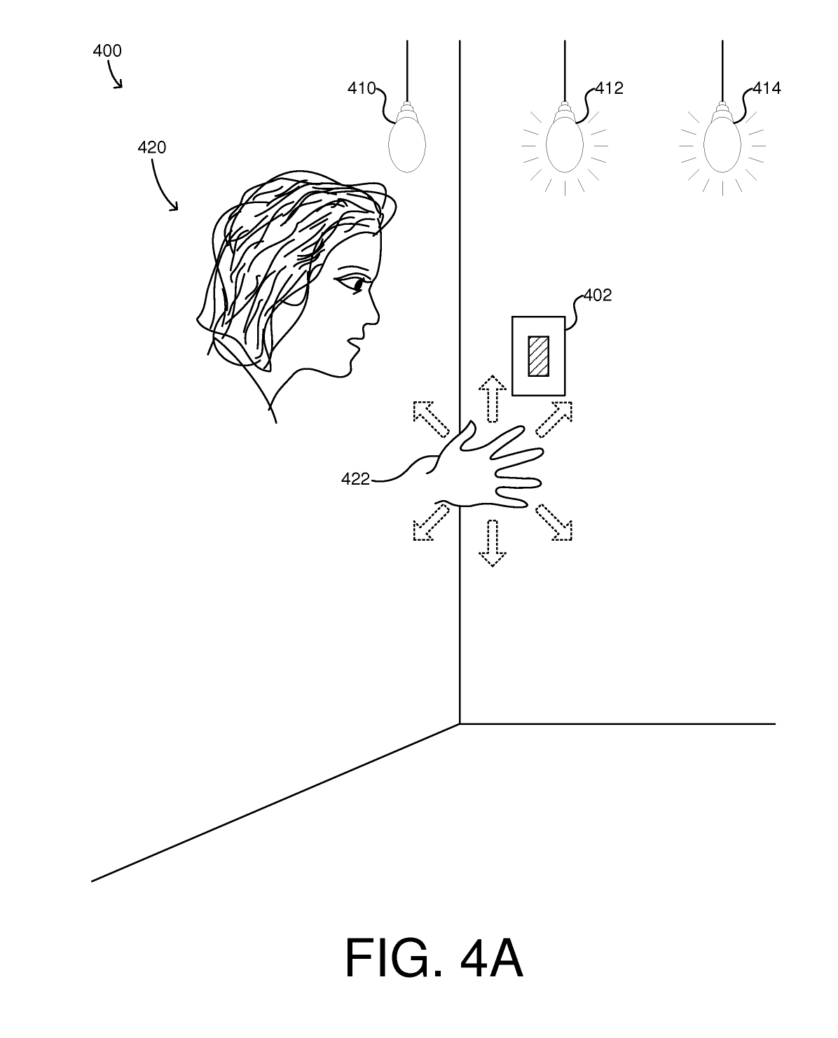

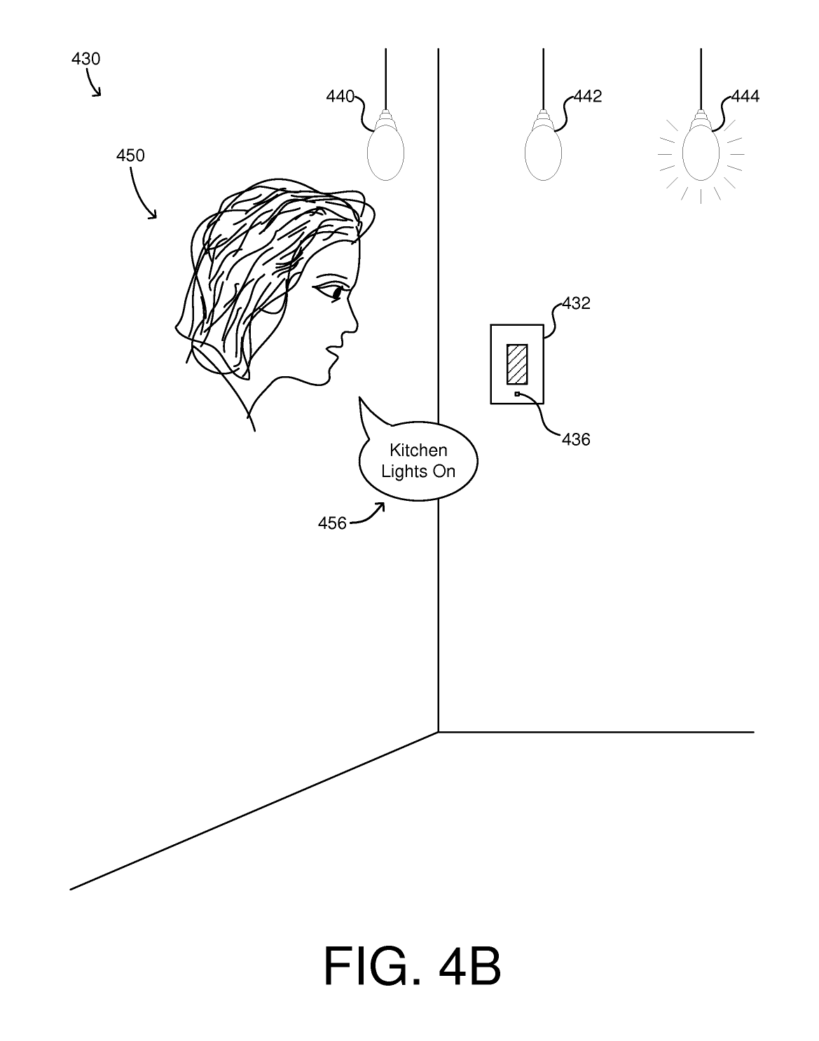

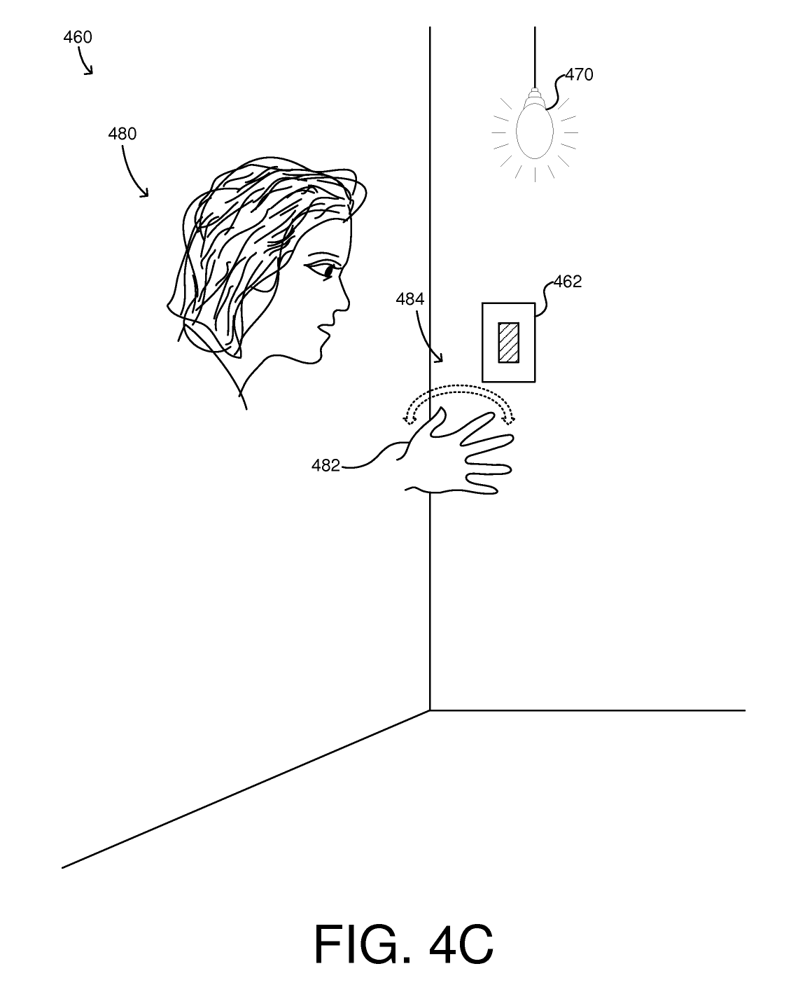

With reference now to FIG. 4A, an example scenario 400 for utilizing an interactive controller 402 to operate one or more devices and/or systems is illustrated. In FIG. 4A, the interactive control/switch (i.e., module) 402 can comprise at least one gesture sensor. The module 402 can be configured to control a plurality of devices/systems, such as light sources 410, 412, and 414. As discussed above, there can be variations implemented for the at least one gesture sensor.

In the example of FIG. 4A, the at least one gesture of the module 402 can be configured to determine multiple gestures performed by a user 420. In the example of FIG. 4A, the user 420 can wave his/her hand 422 from a substantially lower right position to a substantially upper left position to turn on light 410. The user 420 can move his/her hand 422 from the substantially upper left position to the substantially lower right position to turn off light 410. Regarding light 412, the user 420 can move his/her hand 422 from a substantially upward position to a substantially downward position to turn off light 412. The user can move his/her hand from the substantially downward position to the substantially upward position to turn on light 412. With regard to light 414, the user can move his/her hand from a substantially upper right position to a substantially lower left position to turn off light 414. The user can move his/her hand from the substantially lower left position to the substantially upper right position to turn on light 414.

FIG. 4B illustrates an example scenario 430 for utilizing an interactive controller 432 to operate one or more devices and/or systems. In FIG. 4B, the interactive control/switch (i.e., module) 432 can comprise at least one audio sensor 436. The module 432 can be configured to control/operate a plurality of devices/systems, such as lights 440, 442, 444. In some embodiments, each device/system can be configured/preset to be associated with a respective identifier. In the example of FIG. 4B, light 440 can be configured/set to have an audio identifier such as “Dining Area Light”. Light 442 can be identified as “Bar Area Light”. Light 444 can be identified as “Kitchen Light”. As such, when the user 450 issues a vocal command (e.g., “Kitchen Lights On” 456), the module 432 can use the at least one audio sensor 436 to detect and recognize the vocal command 456 and subsequently cause light 444 to turn on. In some instances, the identifier for a controlled device/system can be customizable using at least one of a set of predefined identifiers or a vocal recording of a user of the system.

FIG. 4C illustrates an example scenario 460 for utilizing an interactive controller 462 to operate one or more devices and/or systems. In FIG. 4C, the interactive control/switch (i.e., module) 462 can comprise at least one gesture sensor. The at least one gesture of the module 462 can be configured to determine various gestures, including circular/rotational movements/gestures 484. In the example of FIG. 4C, a user 480 can move his/her hand 482 in a counterclockwise circular motion to cause the light 470 to dim and/or turn off over time. In this example, the user 480 can also move his/her hand 482 in a clockwise circular motion to cause the light 470 to brighten and/or turn on over time.

In some embodiments, a user can perform a gesture by obscuring (e.g., covering, blocking, etc.) the at least one gesture sensor for a threshold/minimum amount of time. The interactive control/switch can recognize this “obscuring” gesture (e.g., sensing a sufficient amount of invisible light being reflected back for the threshold/minimum time period). In one example, when the interactive control/switch is configured to control multiple other devices/systems, the “obscuring” gesture can cause the multiple other device/systems to turn off (e.g., assuming at least one of the other devices/systems is on). Continuing with this example, if all of the multiple devices are off, then the “obscuring” gesture can cause all of the multiple devices to turn on.

Moreover, in some embodiments, the gesture sensor can determine a speed associated with a gesture (e.g., the speed/acceleration for a movement of an object). Accordingly, in some embodiments, a particular gesture performed at a speed at least meeting a specified speed threshold can cause a controlled light, for example, to turn on or off, whereas a similar gesture when performed at a speed below a specified speed threshold can cause the controlled light to brighten or dim over time.

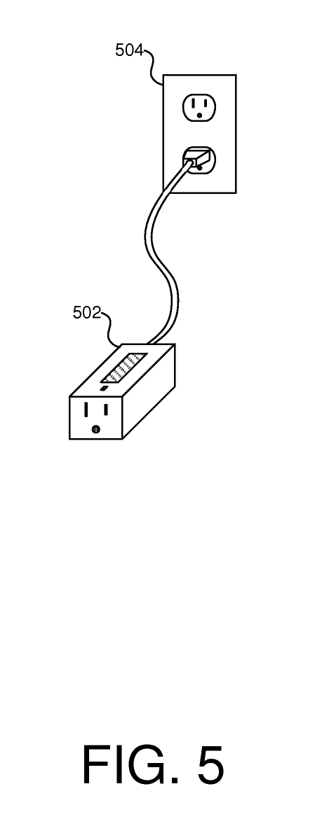

FIG. 5 illustrates an example device embodiment 502 for interactively controlling one or more devices and/or systems. In the example of FIG. 5, the example device 502 embodiment can be portable and can comprise at least one gesture sensor. In some embodiments, the device 502 can comprise at least one audio sensor. As shown in FIG. 5, the device 502 can further comprise an electric energy input element (e.g., electrical plug) configured to receive energy for powering the device 502. For example, the device 502 can be plugged into a power source 504 to receive power. The device 502 can also comprise an electric energy output element (e.g., electrical socket) configured to transmit at least a portion of the received energy to power another electric device (not explicitly shown in FIG. 5). As such, the device 502 can control or operate (e.g., provide power to or limit/cease power provided to) a wide variety of electric devices/systems based on detected/recognized gestures and/or vocal commands.

Furthermore, although not explicitly shown in FIG. 5, in some embodiments, the device can be attachable and detachable from a wall-mounted element (e.g., a wall-mounted light switch element configured to receive/hold the attachable/detachable device). The device can receive power when attached to the wall-mounted element (e.g., to power the device and to recharge the device's batteries). When detached, the device can use the power stored in its batteries.

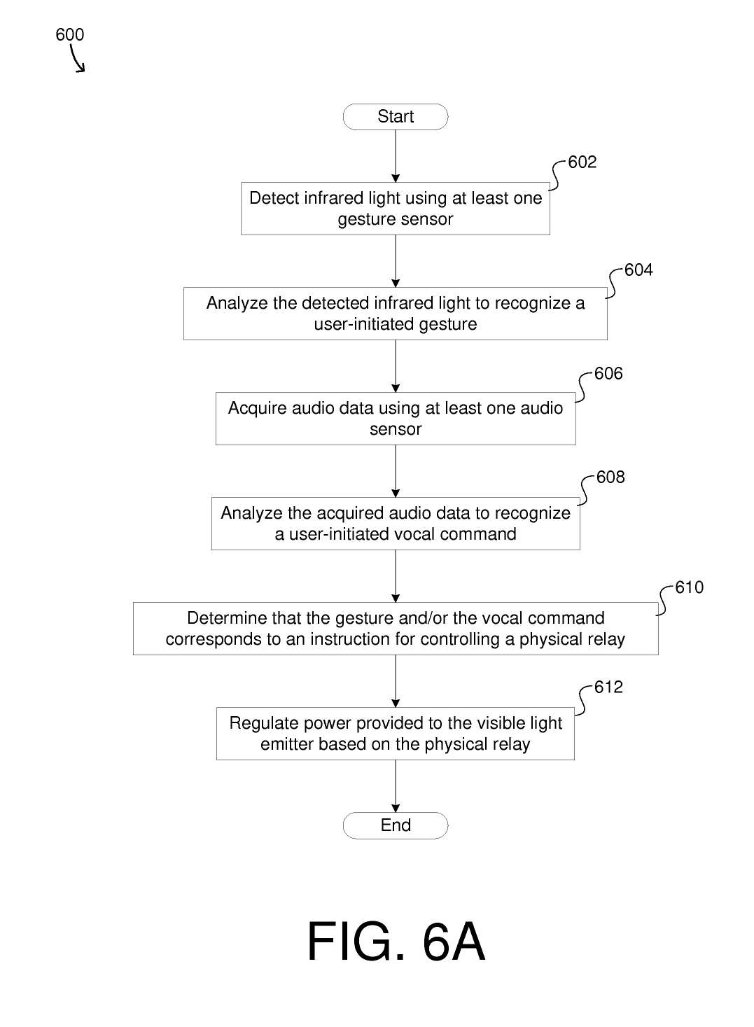

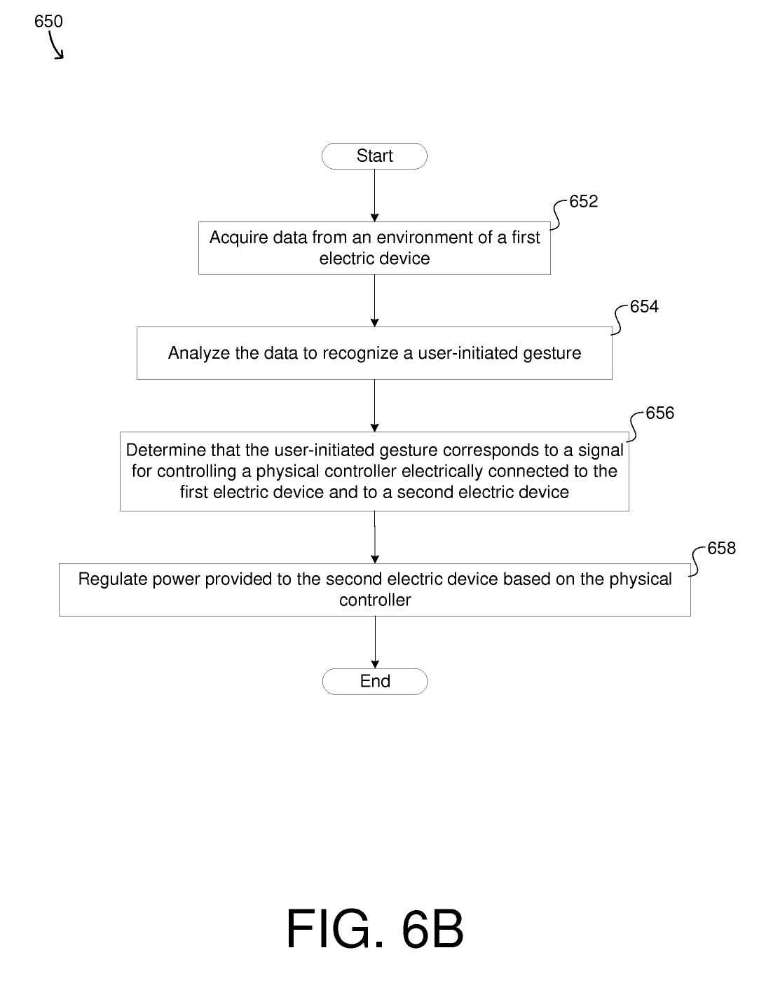

FIG. 6A illustrates an example method embodiment 600 for interactively controlling devices and systems. It should be understood that there can be additional, fewer, or alternative steps performed in similar or alternative orders, or in parallel, within the scope of the various embodiments unless otherwise stated. At step 602, the example method embodiment 600 can detect infrared light using the at least one gesture sensor. In some cases, at least a portion of the detected infrared light can originate from an infrared light emitter associated with the at least one gesture sensor, and can be reflected off of an object (e.g., user's hand). At step 604, the method 600 can analyze at least a portion of the detected infrared light in attempt to recognize a user-initiated gesture.

Step 606 can include acquiring audio data using at least one audio sensor. Then the method 600 can analyze at least a portion of the acquired audio data in attempt to recognize a user-initiated vocal command, at step 608. The method 600 can further determine that at least one of the user-initiated gesture or the user-initiated vocal command corresponds to an instruction for controlling a state of the physical relay, the physical relay (e.g., circuit switch) being configured to provide power to the visible light emitter, at step 610. Step 612 can include performing at least one of 1) providing power to the visible light emitter or 2) ceasing to provide power to the visible light emitter, based at least in part on the state of the physical relay.

In some embodiments, the physical relay (or other physical controller/component) can be electrically connected to the visible light emitter. The physical relay (or other controller/component) can also be connected to a power supply. Based, at least in part, on a user command(s), the physical relay (or other controller/component) can provide, or cease to provide, power to the visible light emitter, which can cause the visible light emitter to turn on or turn off.

FIG. 6B illustrates an example method embodiment 650 for interactively controlling devices and systems. Again, it should be understood that there can be additional, fewer, or alternative steps performed in similar or alternative orders, or in parallel, within the scope of the various embodiments unless otherwise stated. The example method embodiment 650 can acquire data from an environment of a first electric device, at step 652. In some cases, the data can be obtainable at the environment in which the first electric device is situated. The data can be acquired using one or more sensors of the first electric device. In some instances, the data can include at least one of optical data (e.g., image data, infrared data, etc.), ultrasonic data, or electromagnetic data (e.g., capacitive data). In other words, the first electric device can determine (e.g., detect, identify, recognize, etc.) various gestures using various types of data acquired from various sensors (e.g., optical, audio, electromagnetic, etc.). The method 650 can, at step 654, analyze at least a portion of the data, using at least in part one or more processors of the first electric device, to recognize a user-initiated gesture.

Step 656 can include determining, using at least in part the one or more processors of the first electric device, that the user-initiated gesture corresponds to a signal for controlling a physical controller electrically connected to the first electric device and to a second electric device. In some cases, power can be provided to the second electric device (or system) via the physical controller (e.g., relay, switch, variable resistor, etc.). For example, the first electric device can cause the physical controller (e.g., relay, switch, variable resistor, etc.) to enter a first state (e.g., a relay/switch entering a closed circuit state), which results in power being provided to the other device/system; the electric device can also cause the physical controller to enter a second state (e.g., a relay/switch entering an open circuit state), which results in limiting (e.g., ceasing) power provided to the other device/system. Accordingly, step 658 can include performing at least one of 1) providing power to the second electric device or 2) limiting (e.g., ceasing, reducing, etc.) power provided to the second electric device, based at least in part on the physical controller.

In some instances, the physical controller electrically connected to the second electric device and configured to provide (or limit) power to the second electric device can be more reliable than various other controllers (e.g., software controllers, etc.). Moreover, in some cases, the physical controller being electrically (e.g., physically) connected to the first electric device and to the second electric device can be more reliable than a wireless connection (e.g., infrared blaster, etc.). Additionally, in some cases, a physical variable resistor can also enable the second electric device or system (e.g., a light, a set of lights) to dim or brighten over time. A person of ordinary skill in the art would also recognize various other advantages of physical controllers (e.g., relays, switches, variable resistors, etc.).

In some embodiments, the method can also acquire audio data using one or more audio sensors of the first electric device. The method can then analyzing at least a portion of the audio data, using at least in part the one or more processors of the first electric device, to recognize a user-initiated vocal command. The method can further include determining, using at least in part the one or more processors of the first electric device, that the user-initiated voice command corresponds to a second signal for controlling the second electric device. The method can then transmit the second signal to the second electric device. In some instances, the second signal can be configured to cause the second electric device to perform a second operation associated with the second signal.

Moreover, in some embodiments, the user-initiated gesture can include at least partially obscuring the one or more sensors for a threshold amount of time. This user-initiated gesture can determined to further correspond to a second signal for controlling a second physical controller electrically connected to the first electric device and to a third electric device. Whether or not power is provided to the third electric device can be based at least in part on the second physical controller.

Additionally, in some embodiments, the method can further acquire ambient light data using an ambient light sensor of the first electric device. The method can also include modifying a mode of operation for one or more optical sensors of the first electric device based, at least in part, on analyzing the acquired ambient light data.

Moreover, in some embodiments, the device/module (e.g., interactive control/switch) (or gesture sensor) can determine a pattern indicated by or represented in the detected infrared light. For example, the detected infrared light can indicate an infrared light wave pattern (e.g., one or more vector changes, particular data points) representing that infrared light from a first infrared emitter is detected before infrared light from a second infrared light emitter is detected. The module can identify a defined pattern (e.g., a known/preset pattern) that matches the determined pattern within an allowable deviation. The defined pattern can correspond to a defined gesture, and a user-initiated gesture can be recognized as corresponding to the defined gesture. For example, if the first infrared emitter is positioned above the second emitter, then the define gesture can be recognized as corresponding to a downward gesture. Further, in some embodiments, the defined patterned can correspond to at least one of a preset gesture or a gesture customized/set by the user of the module.

Various embodiments can also enable communication between multiple devices/modules/systems. For example, each device or module (e.g., interactive control/switch) can also comprise a communication transceiver, such as a WiFi and/or Bluetooth transceiver. As such, multiple devices/modules can communicate with one another for various purposes. Additionally, a user can also communicate with the devices/modules via a communication network (e.g., Internet, local network, etc.), such as by using an application (i.e., app) on a computing device (i.e., client device). In one example, the user can use an app on his or her computing device to check whether the lights at home are turned on/off, and/or to turn on/off the lights at home, even if the user is not at home.

It is further contemplated that there can be many other uses, applications, and/or variations associated with the various embodiments of the present disclosure that a person of ordinary skill in the art would recognize.

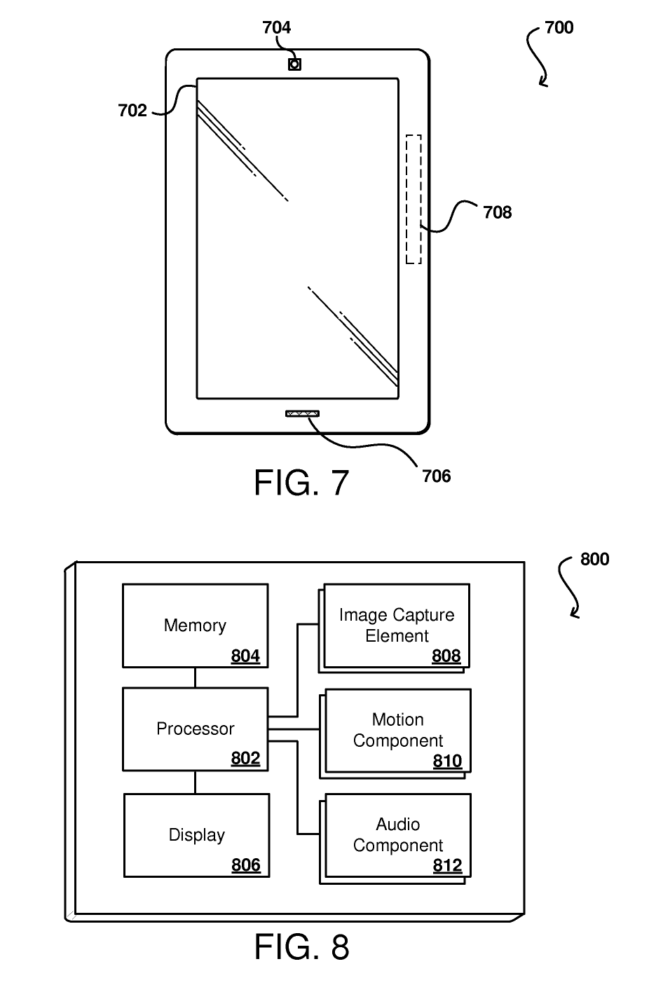

FIG. 7 illustrates an example electronic user device 700 that can be used in accordance with various embodiments. Although a portable computing device (e.g., an electronic book reader or tablet computer) is shown, it should be understood that any electronic device capable of receiving, determining, and/or processing input can be used in accordance with various embodiments discussed herein, where the devices can include, for example, desktop computers, notebook computers, personal data assistants, smart phones, video gaming consoles, television set top boxes, and portable media players. In some embodiments, a computing device can be an analog device, such as a device that can perform signal processing using operational amplifiers. In this example, the computing device 700 has a display screen 702 on the front side, which under normal operation will display information to a user facing the display screen (e.g., on the same side of the computing device as the display screen). The computing device in this example includes at least one camera 704 or other imaging element for capturing still or video image information over at least a field of view of the at least one camera. In some embodiments, the computing device might only contain one imaging element, and in other embodiments the computing device might contain several imaging elements. Each image capture element may be, for example, a camera, a charge-coupled device (CCD), a motion detection sensor, or an infrared sensor, among many other possibilities. If there are multiple image capture elements on the computing device, the image capture elements may be of different types. In some embodiments, at least one imaging element can include at least one wide-angle optical element, such as a fish eye lens, that enables the camera to capture images over a wide range of angles, such as 180 degrees or more. Further, each image capture element can comprise a digital still camera, configured to capture subsequent frames in rapid succession, or a video camera able to capture streaming video.

The example computing device 700 also includes at least one microphone 706 or other audio capture device capable of capturing audio data, such as words or commands spoken by a user of the device. In this example, a microphone 706 is placed on the same side of the device as the display screen 702, such that the microphone will typically be better able to capture words spoken by a user of the device. In at least some embodiments, a microphone can be a directional microphone that captures sound information from substantially directly in front of the microphone, and picks up only a limited amount of sound from other directions. It should be understood that a microphone might be located on any appropriate surface of any region, face, or edge of the device in different embodiments, and that multiple microphones can be used for audio recording and filtering purposes, etc.

The example computing device 700 also includes at least one orientation sensor 708, such as a position and/or movement-determining element. Such a sensor can include, for example, an accelerometer or gyroscope operable to detect an orientation and/or change in orientation of the computing device, as well as small movements of the device. An orientation sensor also can include an electronic or digital compass, which can indicate a direction (e.g., north or south) in which the device is determined to be pointing (e.g., with respect to a primary axis or other such aspect). An orientation sensor also can include or comprise a global positioning system (GPS) or similar positioning element operable to determine relative coordinates for a position of the computing device, as well as information about relatively large movements of the device. Various embodiments can include one or more such elements in any appropriate combination. As should be understood, the algorithms or mechanisms used for determining relative position, orientation, and/or movement can depend at least in part upon the selection of elements available to the device.

FIG. 8 illustrates a logical arrangement of a set of general components of an example computing device 800 such as the device 700 described with respect to FIG. 7. In this example, the device includes a processor 802 for executing instructions that can be stored in a memory device or element 804. As would be apparent to one of ordinary skill in the art, the device can include many types of memory, data storage, or non-transitory computer-readable storage media, such as a first data storage for program instructions for execution by the processor 802, a separate storage for images or data, a removable memory for sharing information with other devices, etc. The device typically will include some type of display element 806, such as a touch screen or liquid crystal display (LCD), although devices such as portable media players might convey information via other means, such as through audio speakers. As discussed, the device in many embodiments will include at least one image capture element 808 such as a camera or infrared sensor that is able to image projected images or other objects in the vicinity of the device. Methods for capturing images or video using a camera element with a computing device are well known in the art and will not be discussed herein in detail. It should be understood that image capture can be performed using a single image, multiple images, periodic imaging, continuous image capturing, image streaming, etc. Further, a device can include the ability to start and/or stop image capture, such as when receiving a command from a user, application, or other device. The example device similarly includes at least one audio capture component 812, such as a mono or stereo microphone or microphone array, operable to capture audio information from at least one primary direction. A microphone can be a uni- or omni-directional microphone as known for such devices.

In some embodiments, the computing device 800 of FIG. 8 can include one or more communication elements (not shown), such as a Wi-Fi, Bluetooth, RF, wired, or wireless communication system. The device in many embodiments can communicate with a network, such as the Internet, and may be able to communicate with other such devices. In some embodiments the device can include at least one additional input device able to receive conventional input from a user. This conventional input can include, for example, a push button, touch pad, touch screen, wheel, joystick, keyboard, mouse, keypad, or any other such device or element whereby a user can input a command to the device. In some embodiments, however, such a device might not include any buttons at all, and might be controlled only through a combination of visual and audio commands, such that a user can control the device without having to be in contact with the device.

The device 800 also can include at least one orientation or motion sensor 810. As discussed, such a sensor can include an accelerometer or gyroscope operable to detect an orientation and/or change in orientation, or an electronic or digital compass, which can indicate a direction in which the device is determined to be facing. The mechanism(s) also (or alternatively) can include or comprise a global positioning system (GPS) or similar positioning element operable to determine relative coordinates for a position of the computing device, as well as information about relatively large movements of the device. The device can include other elements as well, such as may enable location determinations through triangulation or another such approach. These mechanisms can communicate with the processor 802, whereby the device can perform any of a number of actions described or suggested herein.

As an example, a computing device such as that described with respect to FIG. 7 can capture and/or track various information for a user over time. This information can include any appropriate information, such as location, actions (e.g., sending a message or creating a document), user behavior (e.g., how often a user performs a task, the amount of time a user spends on a task, the ways in which a user navigates through an interface, etc.), user preferences (e.g., how a user likes to receive information), open applications, submitted requests, received calls, and the like. As discussed above, the information can be stored in such a way that the information is linked or otherwise associated whereby a user can access the information using any appropriate dimension or group of dimensions.

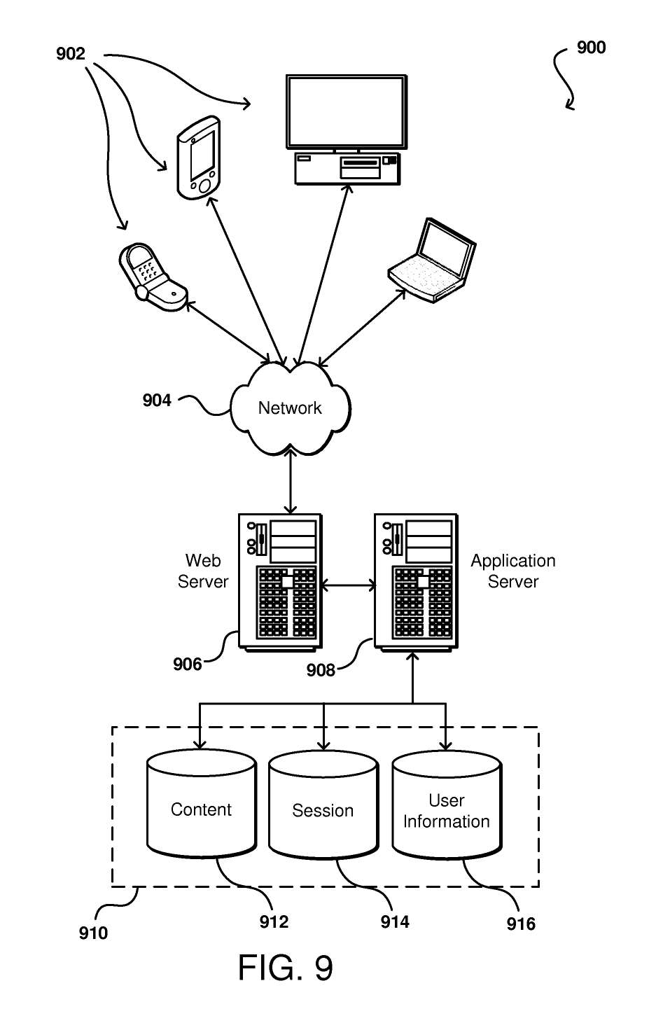

As discussed, different approaches can be implemented in various environments in accordance with the described embodiments. For example, FIG. 9 illustrates an example of an environment 900 for implementing aspects in accordance with various embodiments. As will be appreciated, although a Web-based environment is used for purposes of explanation, different environments may be used, as appropriate, to implement various embodiments. The system includes an electronic client device 902, which can include any appropriate device operable to send and receive requests, messages or information over an appropriate network 904 and convey information back to a user of the device. Examples of such client devices include personal computers, cell phones, handheld messaging devices, laptop computers, set-top boxes, personal data assistants, electronic book readers and the like. The network can include any appropriate network, including an intranet, the Internet, a cellular network, a local area network or any other such network or combination thereof. Components used for such a system can depend at least in part upon the type of network and/or environment selected. Protocols and components for communicating via such a network are well known and will not be discussed herein in detail. Communication over the network can be enabled via wired or wireless connections and combinations thereof. In this example, the network includes the Internet, as the environment includes a Web server 906 for receiving requests and serving content in response thereto, although for other networks an alternative device serving a similar purpose could be used, as would be apparent to one of ordinary skill in the art.

The illustrative environment includes at least one application server 908 and a data store 910. It should be understood that there can be several application servers, layers or other elements, processes or components, which may be chained or otherwise configured, which can interact to perform tasks such as obtaining data from an appropriate data store. As used herein the term “data store” refers to any device or combination of devices capable of storing, accessing and retrieving data, which may include any combination and number of data servers, databases, data storage devices and data storage media, in any standard, distributed or clustered environment. The application server can include any appropriate hardware and software for integrating with the data store as needed to execute aspects of one or more applications for the client device and handling a majority of the data access and business logic for an application. The application server provides access control services in cooperation with the data store and is able to generate content such as text, graphics, audio and/or video to be transferred to the user, which may be served to the user by the Web server in the form of HTML, XML or another appropriate structured language in this example. The handling of all requests and responses, as well as the delivery of content between the client device 902 and the application server 908, can be handled by the Web server 906. It should be understood that the Web and application servers are not required and are merely example components, as structured code discussed herein can be executed on any appropriate device or host machine as discussed elsewhere herein.

The data store 910 can include several separate data tables, databases or other data storage mechanisms and media for storing data relating to a particular aspect. For example, the data store illustrated includes mechanisms for storing production data 912 and user information 916, which can be used to serve content for the production side. The data store also is shown to include a mechanism for storing log or session data 914. It should be understood that there can be many other aspects that may need to be stored in the data store, such as page image information and access rights information, which can be stored in any of the above listed mechanisms as appropriate or in additional mechanisms in the data store 910. The data store 910 is operable, through logic associated therewith, to receive instructions from the application server 908 and obtain, update or otherwise process data in response thereto. In one example, a user might submit a search request for a certain type of element. In this case, the data store might access the user information to verify the identity of the user and can access the catalog detail information to obtain information about elements of that type. The information can then be returned to the user, such as in a results listing on a Web page that the user is able to view via a browser on the user device 902. Information for a particular element of interest can be viewed in a dedicated page or window of the browser.

Each server typically will include an operating system that provides executable program instructions for the general administration and operation of that server and typically will include computer-readable medium storing instructions that, when executed by a processor of the server, allow the server to perform its intended functions. Suitable implementations for the operating system and general functionality of the servers are known or commercially available and are readily implemented by persons having ordinary skill in the art, particularly in light of the disclosure herein.

The environment in one embodiment is a distributed computing environment utilizing several computer systems and components that are interconnected via communication links, using one or more computer networks or direct connections. However, it will be appreciated by those of ordinary skill in the art that such a system could operate equally well in a system having fewer or a greater number of components than are illustrated in FIG. 9. Thus, the depiction of the system 900 in FIG. 9 should be taken as being illustrative in nature and not limiting to the scope of the disclosure.

As discussed above, the various embodiments can be implemented in a wide variety of operating environments, which in some cases can include one or more user computers, computing devices, or processing devices which can be used to operate any of a number of applications. User or client devices can include any of a number of general purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially-available operating systems and other known applications for purposes such as development and database management. These devices also can include other electronic devices, such as dummy terminals, thin-clients, gaming systems, and other devices capable of communicating via a network.

Various aspects also can be implemented as part of at least one service or Web service, such as may be part of a service-oriented architecture. Services such as Web services can communicate using any appropriate type of messaging, such as by using messages in extensible markup language (XML) format and exchanged using an appropriate protocol such as SOAP (derived from the “Simple Object Access Protocol”). Processes provided or executed by such services can be written in any appropriate language, such as the Web Services Description Language (WSDL). Using a language such as WSDL allows for functionality such as the automated generation of client-side code in various SOAP frameworks.

Most embodiments utilize at least one network that would be familiar to those skilled in the art for supporting communications using any of a variety of commercially-available protocols, such as TCP/IP, OSI, FTP, UPnP, NFS, CIFS, and AppleTalk. The network can be, for example, a local area network, a wide-area network, a virtual private network, the Internet, an intranet, an extranet, a public switched telephone network, an infrared network, a wireless network, and any combination thereof.

In embodiments utilizing a Web server, the Web server can run any of a variety of server or mid-tier applications, including HTTP servers, FTP servers, CGI servers, data servers, Java servers, and business application servers. The server(s) also may be capable of executing programs or scripts in response requests from user devices, such as by executing one or more Web applications that may be implemented as one or more scripts or programs written in any programming language, such as Java®, C, C# or C++, or any scripting language, such as Perl, Python, or TCL, as well as combinations thereof. The server(s) may also include database servers, including without limitation those commercially available from Oracle®, Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network. In a particular set of embodiments, the information may reside in a storage-area network (“SAN”) familiar to those skilled in the art. Similarly, any necessary files for performing the functions attributed to the computers, servers, or other network devices may be stored locally and/or remotely, as appropriate. Where a system includes computerized devices, each such device can include hardware elements that may be electrically coupled via a bus, the elements including, for example, at least one central processing unit (CPU), at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices such as random access memory (“RAM”) or read-only memory (“ROM”), as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or Web browser. It should be appreciated that alternate embodiments may have numerous variations from that described above. For example, customized hardware might also be used and/or particular elements might be implemented in hardware, software (including portable software, such as applets), or both. Further, connection to other computing devices such as network input/output devices may be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, EEPROM, flash memory or other memory technology, CD-ROM, digital versatile disk (DVD) or other optical storage, magnetic cassettes, magnetic tape, magnetic disk storage or other magnetic storage devices, or any other medium which can be used to store the desired information and which can be accessed by the a system device. Based on the disclosure and teachings provided herein, a person of ordinary skill in the art will appreciate other ways and/or methods to implement the various embodiments.

The specification and drawings are, accordingly, to be regarded in an illustrative rather than a restrictive sense. It will, however, be evident that various modifications and changes may be made thereunto without departing from the broader spirit and scope of the invention as set forth in the claims.

What is claimed is:

1. A system comprising:
a wall-mounted module for controlling a visible light emitter, the wall-mounted module comprising:
at least one gesture sensor;
at least one audio sensor;
a physical relay electrically connected to the visible light emitter;
at least one processor; and
a memory device including instructions that, when executed by the at least one processor, cause the wall-mounted module to:
detect infrared light using the at least one gesture sensor;
analyze at least a portion of the detected infrared light in attempt to recognize a user-initiated gesture;
acquire audio data using the at least one audio sensor;
analyze at least a portion of the acquired audio data in attempt to recognize a user-initiated vocal command;
determine that at least one of the user-initiated gesture or the user-initiated vocal command corresponds to an instruction for controlling a state of the physical relay, the physical relay being configured to provide power to the visible light emitter; and
perform at least one of, 1) providing power to the visible light emitter or 2) ceasing to provide power to the visible light emitter, based at least in part on the state of the physical relay.

2. The system of claim 1, wherein the instructions, when executed by the at least one processor, further cause the wall-mounted module to:
emit infrared light using an infrared light emitting component associated with the at least one gesture sensor, wherein the detected infrared light includes at least a portion of the emitted infrared light, the at least the portion of the emitted infrared light being reflected off an object within an allowable distance from the at least one gesture sensor.

3. The system of claim 1, wherein analyzing the at least the portion of the detected infrared light in attempt to recognize the user-initiated gesture further comprises:
determining a pattern indicated by the detected infrared light;
identifying a defined pattern that matches the determined pattern within an allowable deviation, the defined pattern corresponding to a defined gesture, wherein the user-initiated gesture is recognized as corresponding to the defined gesture.

4. The system of claim 3, wherein the defined patterned corresponds to at least one of a preset gesture or a gesture customized by a user of the system.

5. The system of claim 1, wherein power is provided to the visible light emitter when the user-initiated gesture includes a substantially upward moving gesture, and wherein power is ceased to be provided to the visible light emitter when the user-initiated gesture includes a substantially downward moving gesture.

6. The system of claim 1, wherein analyzing the at least the portion of the acquired audio data in attempt to recognize the user-initiated vocal command further comprises:
applying a speech recognition process to the at least the portion of the acquired audio data in attempt to recognize the user-initiated vocal command.

7. The system of claim 6, wherein the instructions, when executed by the at least one processor, further cause the wall-mounted module to:
facilitate in configuring a vocal identifier for the visible light emitter, wherein the vocal identifier enables the visible light emitter to be distinguishable from a second visible light emitter, and wherein the user-initiated vocal command includes the vocal identifier for the visible light emitter.

8. The system of claim 7, wherein the vocal identifier for the visible light emitter is customizable using at least one of a set of predefined vocal identifiers or a vocal recording of a user of the system.

9. The system of claim 1, wherein the at least one audio sensor comprises at least a first audio sensor and a second audio sensor, wherein the first audio sensor is separated from the second audio sensor by a specified distance, wherein the audio data is acquired using, at least in part, the first audio sensor and the second audio sensor, and wherein the instructions, when executed by the at least one processor, further cause the wall-mounted module to:
determine locational information associated with a source that produces sound corresponding to the acquired audio data, the locational information being determined using, at least in part, the first audio sensor and the second audio sensor.

10. A computer-implemented method comprising:
acquiring data from an environment of a first electric device, the data being acquired using one or more sensors of the first electric device, the data including at least one of optical data, ultrasonic data, or electromagnetic data;
analyzing at least a portion of the data, using at least in part one or more processors of the first electric device, to recognize a user-initiated gesture;
determining, using at least in part the one or more processors of the first electric device, that the user-initiated gesture corresponds to a signal for controlling a physical controller electrically connected to the first electric device and to a second electric device; and
performing at least one of, 1) providing power to the second electric device or 2) limiting power provided to the second electric device, based at least in part on the physical controller.

11. The computer-implemented method of claim 10, further comprising:
acquiring audio data using one or more audio sensors of the first electric device;
analyzing at least a portion of the audio data, using at least in part the one or more processors of the first electric device, to recognize a user-initiated vocal command; and
determining, using at least in part the one or more processors of the first electric device, that the user-initiated voice command corresponds to a second signal for controlling the physical controller.

12. The computer-implemented method of claim 11, wherein power is provided to the second electric device when at least one of the user-initiated gesture corresponds to a substantially upward moving gesture or the user-initiated vocal command includes a first key phrase, and wherein limiting power provided to the second electric device occurs when at least one of the user-initiated gesture includes a substantially downward moving gesture or the user-initiated vocal command includes a second key phrase.

13. The computer-implemented method of claim 10, wherein the user-initiated gesture includes at least partially obscuring the one or more sensors for a threshold amount of time, wherein the user-initiated gesture is determined to further correspond to a second signal for controlling a second physical controller electrically connected to the first electric device and to a third electric device, and wherein how much power is provided to the third electric device is based at least in part on the second physical controller.

14. The computer-implemented method of claim 10, wherein the second electric device is a visible light emitter, and wherein the method further comprises:
determining that a speed associated with the user-initiated gesture is below a specified threshold, wherein the physical controller causes visible light emitted at the visible light emitter to be dimmed over time when the user-initiated gesture corresponds to a substantially downward moving gesture performed at the determined speed; or
determining that the speed associated with the user-initiated gesture at least meets the specified threshold, wherein the physical controller causes visible light emitted at the visible light emitter to brighten over time when the user-initiated gesture corresponds to a substantially upward moving gesture performed at the determined speed.

15. The computer-implemented method of claim 10, further comprising:
analyzing the at least the portion of the data, using at least in part the one or more processors of the first electric device, to recognize a second user-initiated gesture;
determining, using at least in part the one or more processors of the first electric device, that the second user-initiated gesture corresponds to a second signal for controlling the physical controller.

16. The computer-implemented method of claim 10, further comprising:
acquiring ambient light data using an ambient light sensor of the first electric device; and
modifying a mode of operation for the one or more sensors of the first electric device based, at least in part, on analyzing the acquired ambient light data.

17. The computer-implemented method of claim 10, further comprising:
establishing a wireless communicative connection between the first electric device and a third electric device;
receiving, at the first electric device, via the wireless communicative connection, at least one signal from the third electric device for controlling the physical controller.

18. A portable electric device comprising:
one or more sensors;
at least one processor; and
a memory device including instructions that, when executed by the at least one processor, cause the portable electric device to:
acquire data obtainable at an environment in which the portable electric device is situated, the data being acquired using the one or more sensors, the data including at least one of optical data, ultrasonic data, or electromagnetic data;
analyze at least a portion of the data, using at least in part the at least one processor of the portable electric device, to recognize a user-initiated gesture;
determine, using at least in part the at least one processor of the portable electric device, that the user-initiated gesture corresponds to a signal for controlling a physical controller electrically connected to the portable electric device and to a separate electric device that is separate from the portable electric device; and
perform at least one of, 1) providing power to the separate electric device or 2) limiting power provided to the separate electric device, based at least in part on the physical controller.

19. The portable electric device 18, further comprising:
an electric energy input element configured to receive energy for powering the portable electric device;
an electric energy output element configured to transmit at least a portion of the received energy to power the separate electric device.

20. The portable electric device of claim 18, wherein the portable electric device is attachable and detachable from a wall-mounted element.
